(19) United States
(12) Patent Application Publication
(10) Pub. No.: US 2026/0115678 A1
(43) Pub. Date: Apr. 30, 2026

(54) GASIFICATION DEVICE

(71) Applicant: Helmholtz-Zentrum Dresden-Rossendorf e.V., Dresden (DE)

(72) Inventors: Ehsan MOHSENI, Dresden (DE); Sebastian REINECKE, Dresden (DE); Uwe HAMPEL, Dresden (DE)

(21) Appl. No.: 18/836,411

(22) PCT Filed: Feb. 6, 2023
(86) PCT No.: PCT/EP2023/052859

§ 371 Date: Aug. 7, 2024

(30) Foreign Application Priority Data
Feb. 8, 2022 (DE) 10 2022 201 292.5

(51) Int. Cl. B01J 4/00; A01K 63/04; B01D 65/02; B01F 23/23; B01F 23/231; B01F 35/221; B01F 101/00; B01F 101/49; B01J 10/00; B01J 19/00; B01J 19/24; B03D 1/24; C02F 1/78; C02F 3/20

(52) U.S. Cl. CPC B01J 4/008; A01K 63/042; B01D 65/02; B01F 23/23121; B01F 23/238; B01F 35/2211; B01F 35/2213; B01J 4/001; B01J 10/002; B01J 19/0006; B01J 19/24; C02F 1/78; C02F 3/20; B01D 2321/185; B01F 2101/2204; B01F 2101/305; B01F 2101/49; B01J 2204/002; B01J 2219/00162; B01J 2219/00164; B03D 1/24

(57) ABSTRACT

A gasification device for gasification of a liquid medium with a gas supply, a control unit, a gas modulation unit and a bubble diffuser. The gas supply supplies a gas to the control unit, the gas modulation unit and the bubble diffuser. The control unit controls the gas volume flow or the pressure of the gas supplied to the gas modulation unit and to supply it to the gas modulation unit with a constant gas volume flow and/or a constant gas pressure. The gas modulation unit varies the gas volume flow and/or the pressure and supplies it to the liquid medium via the bubble diffuser provided with at least one opening, so that at least one bubble is formed at the opening of the bubble diffuser in the liquid medium.

The present invention relates to a gasification device for gasification of a liquid medium.

In many industrial processes, a gas must be dissolved or distributed in a liquid. As a rule, small gas bubbles are used for this purpose in order to improve heat and mass transfer. Such processes are used particularly in the fields of chemistry, biochemistry, mining, environmental process engineering or food production, for example in waste water treatment, mineral processing, yeast production or for cooling processes. Unfortunately, generating small bubbles is a major challenge here. The energy balance in particular is often disadvantageous, with DE 20 2017 002 548 U1, for example, disclosing a corresponding arrangement for gasification that aims to achieve a better energy balance. The disadvantage here, however, is that the arrangement is not very flexible.

In prior art processes and methods, it is often not possible to control the formation of the bubbles (and therefore also the bubble sizes). Conventional membrane gasifiers or aerators, for example, generate gas bubbles with a diameter of around 2 mm, whereby the way they work with a membrane means that the gas bubble size can only be roughly controlled by the size of the openings in the membrane, which are created as perforations.

An obvious solution to this problem is to use smaller openings. The problem here, however, is that due to the greater dynamics that smaller openings entail, the so-called “bubble-in-rush” effect occurs, in which new bubbles are formed so quickly at the opening where the bubble forms that the initially formed bubble has not yet been able to detach itself and is combined with the subsequent bubble, so that the bubble size increases.

The present invention is therefore based on the object of proposing a gasification device which avoids the aforementioned disadvantages, i.e. with which the smallest possible bubbles can be reliably produced in a controlled manner with low dispersion of the bubble size.

According to the invention, this object is attained by a device according to claim 1. Advantageous embodiments and further developments are described in the dependent claims.

A gasification device for gasification of a liquid medium, typically a liquid, i.e. a substance that is in a liquid aggregate state, has a gas supply, a control unit, a gas modulation unit and a bubble diffuser. The gas supply is configured to supply a gas to the control unit, the gas modulation unit and the bubble diffuser, the control unit being configured to control the gas volume flow or the pressure of the gas supplied to the gas modulation unit in such a way that the gas is supplied to the gas modulation unit at a constant gas volume flow and/or a constant gas pressure. The gas modulation unit is configured or designed to vary the gas volume flow and/or the pressure of the gas and to supply it to the liquid medium via the bubble diffuser provided with at least one opening, so that at least one bubble forms at the opening of the bubble diffuser in the liquid medium.

With a constant gas pressure or a constant gas volume flow, a more uniform bubble formation can be achieved and the parameters of the bubbles, such as size and frequency of formation, can be more easily adjusted depending on other parameters. The gas modulation unit provides an easy-to-use tool for this purpose, which can also be used flexibly. In addition, undesirable phenomena such as “bubble in-rush” can be avoided and smaller bubble diameters can be produced in contrast to previously employed methods, typically in the submillimeter range. In addition, the generated bubbles differ only slightly in size from one another. For the purposes of this specification, the term “gasification” refers to the introduction of gases into a liquid medium, whereby here in the case of aeration, this refers to the introduction of air or oxygen into a liquid medium.

The gas modulation unit typically modulates the gas with an acoustic wave in the frequency range of 150 Hz to 180 Hz to enable efficient and reliable formation of bubbles. The gas modulation unit can have at least one electrically controllable actuator, in particular an electro-acoustic transducer and/or at least one electro-acoustic actuator, for example a loudspeaker or a pneumatic oscillator, in order to reliably modulate or vary the pressure of the gas or the gas volume flow in such a way that targeted bubble formation is made possible. Preferably, the actuator and in particular the electro-acoustic transducer or actuator is operated at a frequency of less than 1 kHz, particularly preferably in the frequency range from 150 Hz to 250 Hz, especially 150 Hz to 180 Hz. The actuator (in particular the transducer) can be configured to generate a pressure amplitude, whereby the maximum value of the pressure can be up to 30 percent above the critical pressure, i.e. up to 30 percent above the minimum pressure required to cause bubbles to form spontaneously in the respective liquid. Generally speaking, the actuator can be configured to generate a pressure gradient sufficient for bubble formation. As an alternative to an electro-acoustic transducer and/or electro-acoustic actuator, the actuator can, for example, be a pneumatic actuator and/or be configured to generate or emit compressed air. Furthermore, alternatively, the actuator can be generally configured to generate mechanical vibrations which can be transmitted to the gas for the purpose of the modulation disclosed here.

The gas modulation unit and the bubble diffuser can be designed together in one piece, i.e. consist of a single part or be combined in a single component, which is also referred to as a monolithic design or integral design and enables a particularly compact and mechanically stable design. This results in a particularly compact design. Alternatively, it is of course also possible to design both units in two parts, i.e. to provide two components connected to each other by the gas supply or gas supply unit in order to create an arrangement that is as flexible as possible.

The gas supply is typically designed as a pipe that connects the aforementioned units with each other and originates from a gas source. To enable a targeted gas flow, an openable and closable valve can also be arranged on the gas supply, usually sandwiched between the gas source and the control unit. The gas supply is typically designed in this regard with a round cross-section, although an oval, rectangular or square cross-section can also be provided in other exemplary embodiments.

The bubble diffuser can have several openings in order to generate several bubbles in a targeted manner. The openings can be identical in their dimensions and shapes, but it is also possible for at least one of the openings to have a shape and/or size that differs from the other openings.

If several openings are used, at least one electrically controllable actuator can be arranged at each of the openings, in particular an electro-acoustic transducer and/or an electro-acoustic actuator, so that bubbles can be generated in a targeted manner at each of these openings and thus different bubble patterns can be produced. Preferably, the respective transducer or actuator is arranged within the bubble diffuser directly below the associated opening. These transducers or actuators can be controlled individually, for example via the control unit, the gas modulation unit and/or an electrical control unit.

The electrical control unit can generally control several units, i.e. the gas source, the valve, the control unit and/or the gas modulation unit and is typically designed as a computer or arithmetic device.

In a preferred manner, an acoustic damping unit is arranged in the bubble diffuser, which serves and is configured to prevent acoustic back reflections (for example of the gas pressure wave) from the end of the gas supply line and thus enables more efficient bubble generation.

It may be provided that the control unit is configured to direct the gas to the gas modulation unit at a gas pressure that is lower than a critical pressure for bubble generation for the respective medium, preferably up to 20 percent lower than a critical pressure for bubble generation for the respective medium. This ensures that bubbles are only generated when the gas pressure is modulated accordingly by the gas modulation unit. In particular, it may be provided that the gas is passed on to the gas modulation unit at a gas pressure which, as described above, is lower than a critical pressure for the respective medium for the generation of bubbles and, in addition, a pressure amplitude is generated by the transducer or actuator, as a result of which the maximum value of the pressure may be up to 30 percent above the critical pressure, i.e. up to 30 percent above the minimum pressure required to cause bubbles to form spontaneously in the respective liquid. Instead of a constant and controlled gas pressure, a constant volume flow that is modulated can also be used, which is usually preferred in industrial processes such as biological waste water treatment. This results in an increased frequency of bubble formation.

The constancy of the gas pressure and/or volume flow can relate to a duration of the gas supply or be present within this duration. Additionally or alternatively, it may be present for at least a period of several tens of minutes or even several hours. The constancy can be within the usual technical tolerances. For example, it can include temporary deviations (for example, for no more than 10 minutes, no more than 2 minutes or no more than 30 seconds) of no more than 10 % or no more than 5 %.

The gas modulation unit can have a signal generator or be connected to a signal generator which is designed to apply periodic and in particular harmonic modulations of adjustable amplitude and frequency to the gas volume flow or the gas pressure through the gas modulation unit. Such periodic and, in particular, harmonic or, in other words, sinusoidal modulations can be used to support or enable the formation of bubbles in a targeted manner and adapted to the respective liquid medium.

The following measures have proven to be advantageous for reliable controllability of bubble formation: A respective period of the modulation comprises a first time proportion with a pressure above a critical pressure for bubble generation for the respective liquid medium and a subsequent second time proportion with a pressure below the critical pressure, wherein:
a) the time proportions are different from each other (i.e. their duration differs from each other); and/or
b) the amounts of the differences of the (maximum) amplitudes of each time proportion to the critical pressure are different from each other; and/or
c) the integrals of the pressure over time within the time proportions or, in other words, over the duration of the time proportions are different from each other.

With regard to variant a), the first time proportion may be longer (for example, at least one and a half times or at least twice as long) than the second time proportion.

With regard to variant b), the amount of the difference between the amplitude of the first time proportion and the critical pressure may be greater (for example, at least one and a half times or at least twice as great) than the amount of the difference of the amplitude of the second time proportion to the critical pressure time.

With regard to variant c), the integral of the pressure over the duration of the first time proportion may be greater than the integral of the pressure over the duration of the second time proportion (for example, at least one and a half times or at least twice as great).

All of the above optional embodiments of variants a)-c) enable particularly reliable control of bubble formation in terms of size and frequency.

The at least one opening typically has a size of 0.5 mm to 1 mm. Preferably, the opening is round, but in further exemplary embodiments an elliptical, rectangular, square or octagonal opening can also be used. The specified size refers to the diameter or length of the opening.

Alternatively or additionally, a funnel-shaped supply may be provided in the bubble diffuser below the opening, the diameter of which decreases in the direction of the opening so that the gas is focused in the direction of the opening.

A gasification tank includes a gasification device with the described features. The gasification device is arranged below a liquid level in the gasification tank, provided the tank is filled with the liquid or liquid medium, and is connected to the gas source typically located outside the gasification tank. The gasification tank, which can also be referred to as a gasification vessel, can be designed to be open on one side, but can also be designed to be closed and be equipped with means for gas recovery.

In a method for generating bubbles in a liquid medium, a gas is passed through the gas supply, the control unit, the gas modulation unit and the bubble diffuser in the gasification tank filled with the liquid medium and having the described features by the gasification device with the said properties arranged below a surface of the liquid medium, wherein the control unit controls the gas volume flow and/or the pressure of the supplied gas so that the gas is supplied to the gas modulation unit at a constant gas volume flow and/or a constant gas pressure, wherein the gas modulation unit provides the gas with a gas pressure modulation and directs or supplies it to the bubble diffuser provided with at least one opening, so that at least one bubble is formed at the opening of the bubble diffuser, which is supplied or fed to the liquid medium.

The method can therefore be carried out with the described gasification tank or the described gasification device, i.e. the gasification tank and the gasification device are designed to carry out this method.

The described gasification device, the described gasification tank and/or the described method can be used for waste water treatment, i.e. the liquid medium is waste water and the gas used is oxygen or air, which is preferably introduced into an activated sludge tank. Alternatively or additionally, the gasification device or method can also be used for the introduction of ozone into a tank for trace elimination filled with liquid, for supplying oxygen in aquaculture or fish farming, for cleaning membrane filters, for flotation in the extraction of raw materials in mining and in mining recycling, for reducing noise emissions in off-shore work by forming at least one bubble curtain, for dispensing medication or for mixing and mass transfer in chemical processes.

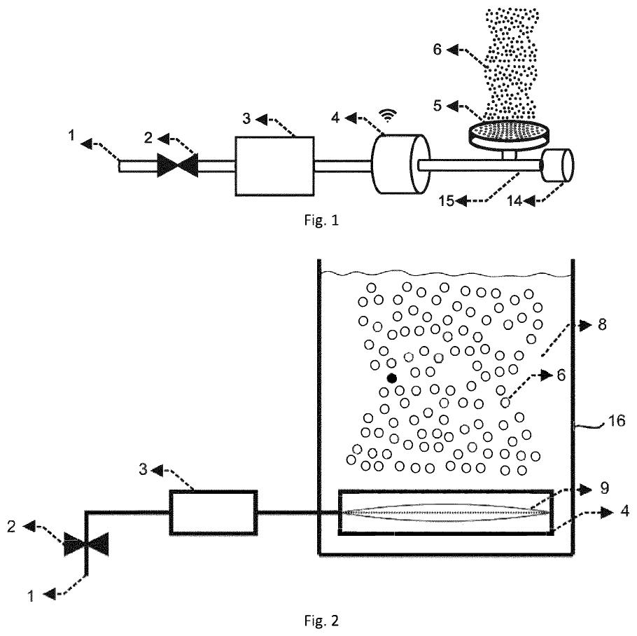

Exemplary embodiments of the invention are shown in the drawings and are explained below with reference to FIGS. 1 to 17.

In the drawings:

FIG. 1 shows a schematic lateral view of a gasification device;

FIG. 2 shows a view of an exemplary embodiment of the gasification device corresponding to FIG. 1 with a one-piece gas modulation unit and bubble diffuser;

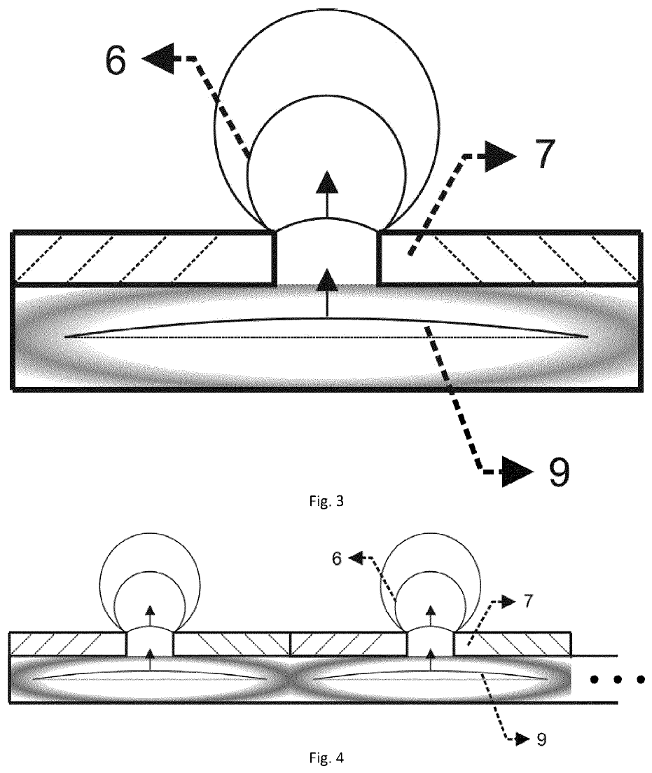

FIG. 3 shows a schematic representation of the formation of a bubble at an opening by an electro-acoustic modulator;

FIG. 4 shows a view with several bubbles forming corresponding to FIG. 3;

FIG. 5 shows a view with the formation of several bubbles by a modulated gas volume flow corresponding to FIG. 3;

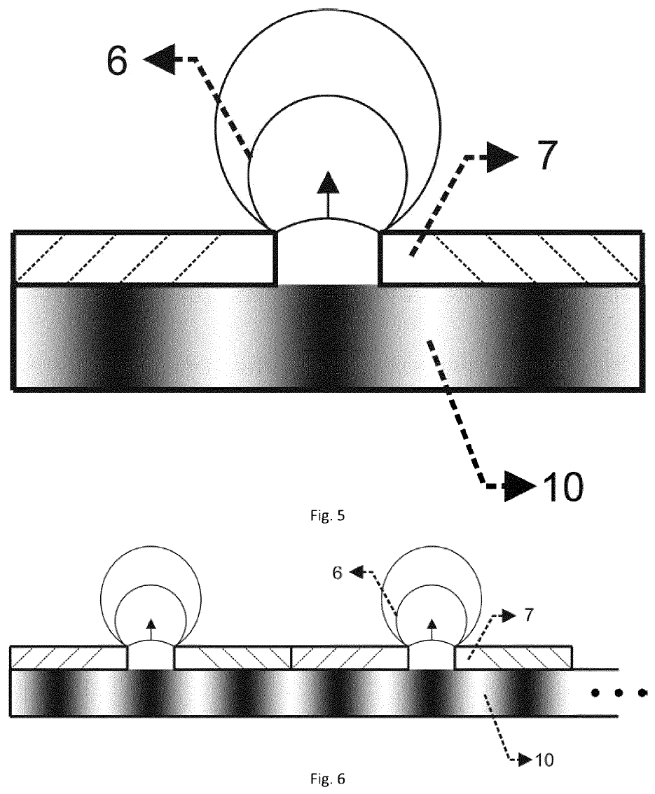

FIG. 6 shows a view corresponding to FIG. 5 with several bubbles;

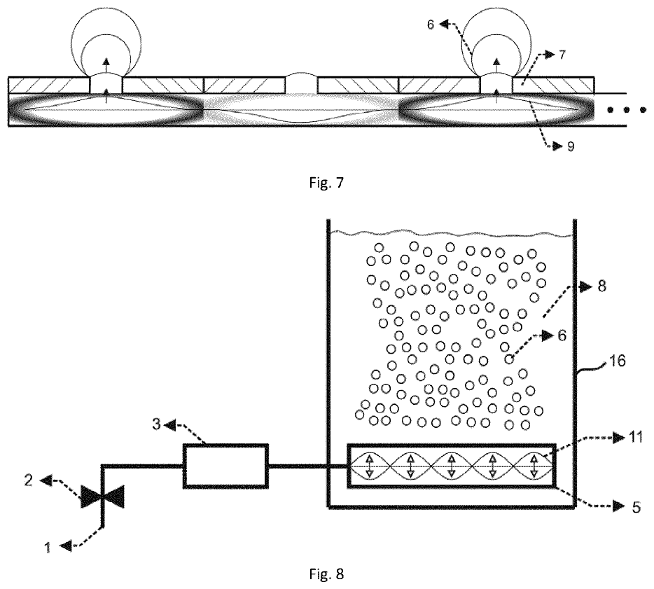

FIG. 7 shows a view of an exemplary embodiment corresponding to FIG. 3, in which bubbles are generated independently from each other at the openings;

FIG. 8 shows a view corresponding to FIG. 1 of a exemplary embodiment with a standing wave in the bubble diffuser;

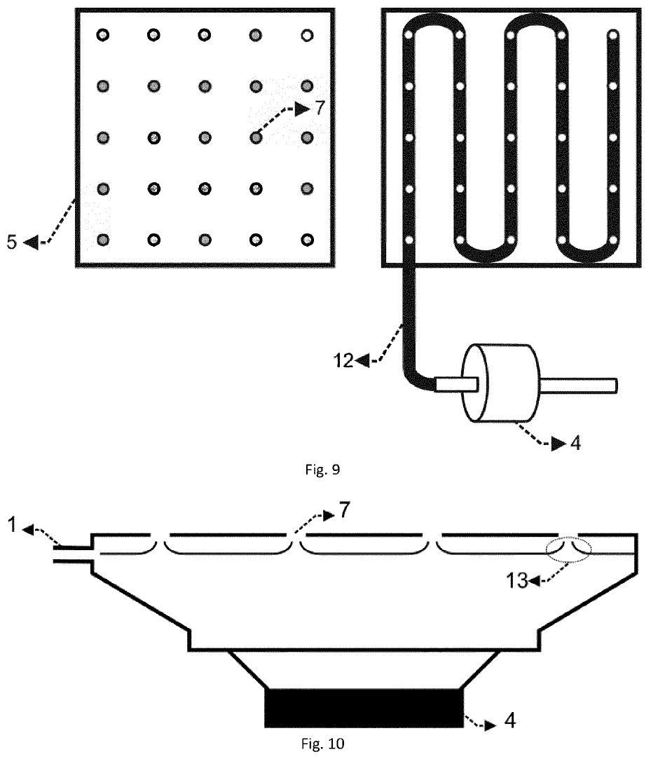

FIG. 9 shows a schematic top view of a gasification device with a meandering pipe;

FIG. 10 shows a side view of a gasification device with funnel-shaped openings;

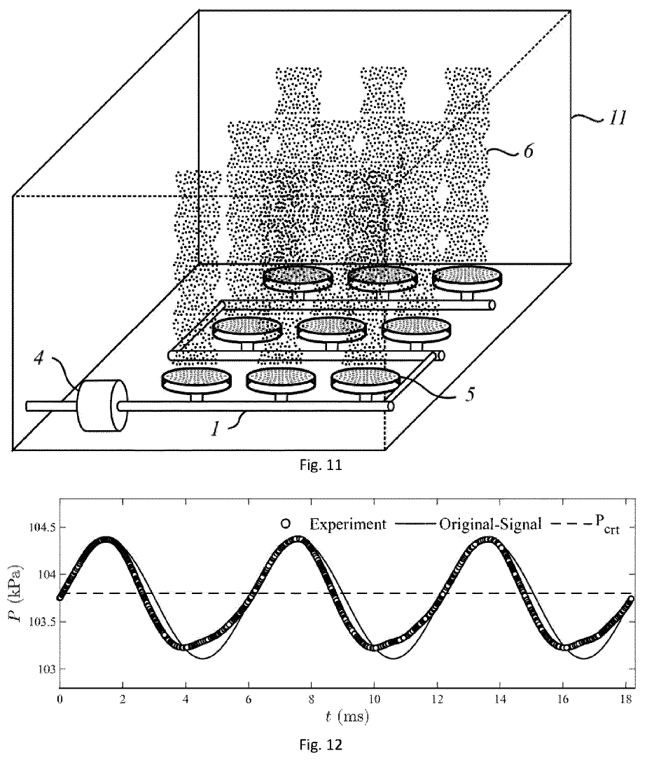

FIG. 11 shows a schematic three-dimensional view of a gasification tank;

FIG. 12 shows a diagram of a modulation of a gas pressure;

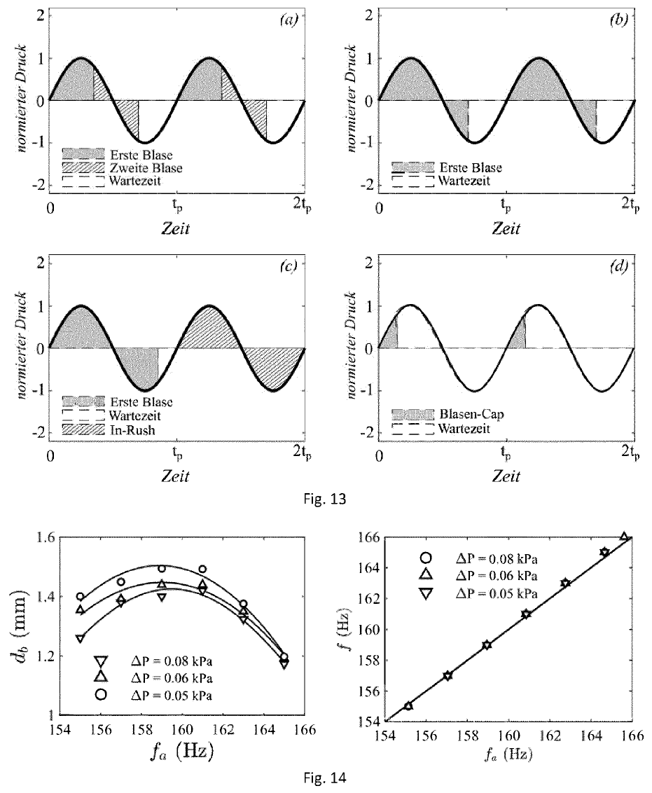

FIG. 13 shows diagrams of different phases of bubble generation;

FIG. 14 shows a diagram of the frequency dependence of bubble size and bubble formation frequency;

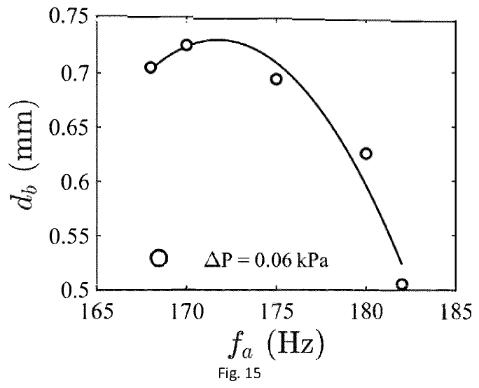

FIG. 15 shows a diagram of a frequency dependence of the bubble size for different frequencies of an acoustic signal;

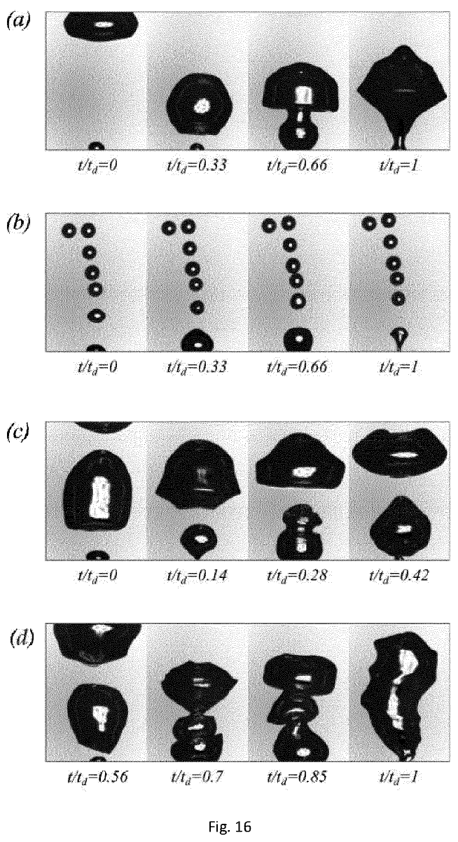

FIG. 16 shows images of the bubble formation and

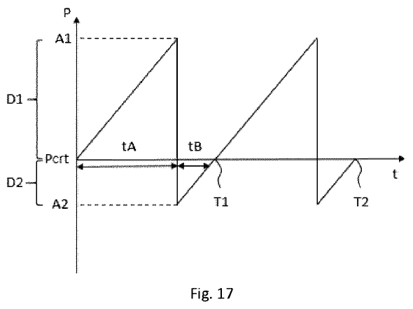

FIG. 17 shows another diagram of a modulation of a gas pressure according to one embodiment of the invention.

FIG. 1 shows a schematic side view of a gasification device or bubble generation device, in which a gas to be used for bubble generation is supplied from a gas source, not shown in FIG. 1 for reasons of clarity, via a gas supply 1, which can also be referred to as a gas supply device. The gas supply 1 can be opened and closed via a valve 2. The control unit 3 controls a gas volume flow or gas flow and/or a gas pressure in such a way that a gas modulation unit 4 is supplied with a constant gas volume flow or a constant gas pressure by the control unit 3 via the tubular gas supply 1. However, if the gas volume flow is kept constant, typically only one bubble formation frequency can be controlled, and with a constant gas pressure, the bubble size can also be controlled. The gas modulation unit 4 provides the gas with gas pressure modulation or gas volume flow modulation, i.e. varies the gas pressure as the pressure of the gas and/or the gas volume flow, and the gas is fed from the gas modulation unit 4 to a bubble diffuser 5 via the gas supply line 1, which is designated and continued after the gas modulation unit 4 in this embodiment example as gas supply line 15. In the exemplary embodiment example shown in FIG. 1, the bubble diffuser 5 is plate-shaped and has a circular surface in which several openings are created. Several bubbles 6 then form at the openings and are released into a liquid. In the exemplary embodiment shown, the gas modulation unit 4 and the bubble diffuser 5 are designed as two separate components, i.e. two spatially spaced components that are connected to each other via the gas supply 1. The modulations are damped by a damping unit 14, which is arranged at the end of the gas supply line 15 and prevents acoustic back reflections in the direction of the gas modulation unit 4.

In FIG. 2, a view corresponding to FIG. 1 shows an exemplary embodiment in which the gas modulation unit 4 and the bubble diffuser 5 are integrally designed, i.e. arranged within a common housing. Recurring features are marked with identical reference symbols in this figure and in the following figures. In addition, a gasification tank 16 is now also shown, which is open on one side facing away from the gasification device and is filled with a liquid 8 or a substance in its liquid phase. The gasification device is arranged below the liquid level, i.e. below the liquid surface, whereby in the illustrated exemplary embodiment only the gas modulation unit 4 and the bubble diffuser 5 designed integrally therewith are arranged inside the gasification tank 16, whereas the valve 2 and the control unit 3 are arranged outside the gasification tank 16. In further exemplary embodiments, however, the control unit 3 and the valve 2 can of course also be arranged inside the gasification tank 16 and only the gas source usually remains outside.

In the exemplary embodiment shown in FIG. 2, the gas modulation unit 4 is equipped with an electro-acoustic actuator 9, which extends over the entire length of the gas modulation unit 4 below the openings 7 and is housed in a gas-tight closed housing except for the gas supply 1 and the openings 7. This actuator 9 generates gas pressure fluctuations that lead to the formation of bubbles at the openings 7.

Similarly, FIG. 4 shows an exemplary embodiment in a view corresponding to FIG. 3, in which several openings 7 are arranged next to each other, on each of which a bubble 6 is formed. A separate electro-acoustic actuator 9 is arranged below each of the openings 7, whereby the electro-acoustic actuators 9 can be controlled independently of one another as modulators. For example, a computer can be used to control the gas modulation unit 4 (and thus also the electro-acoustic modulators 9) and the control unit 3.

FIG. 5 shows one of the openings 7 in a view corresponding to FIG. 3, although the bubble generation is not generated by an electro-acoustic actuator 9, but rather by a modulation of the gas pressure, i.e. a gas pressure wave 10 propagates in the gas modulation unit 4. A corresponding arrangement with several openings 7, at each of which a bubble 6 is generated, is shown in FIG. 6 in a view corresponding to FIG. 3.

By arranging a separate electro-acoustic actuator 9 below each of the openings 7, any bubble pattern can be produced, as shown in FIG. 7. While bubbles 6 are formed at two of the openings 7 in the exemplary embodiment shown in FIG. 7, no bubble 6 is formed at the middle opening 7 by corresponding control. In this case, bubbles are not generated simultaneously even at adjacent openings 7.

In addition, provision may also be made to form a standing wave 11 within the gas modulation unit 4, as shown in FIG. 8 in a view corresponding to FIG. 1. The formation of the standing wave, i.e. the frequency range in question, naturally depends on the length and width of the bubble diffuser 5. Due to the length of the bubble diffuser 5, the standing wave 11 forms inside the housing, which can increase the energy efficiency of the gas modulation unit 4. The acoustic wave can be guided parallel or at right angles to the openings 7.

In addition, the efficiency can also be increased by designing the gas supply 1 in a meandering shape or by providing a pipe 12 perforated with the openings 7 or a correspondingly perforated channel downstream of the gas modulation unit 4. In the exemplary embodiment shown, the openings 7 are all located on the same side of the pipe 12, i.e. their surface normals all point in the same direction. FIG. 9 shows a top view of the upper side of the bubble diffuser 5 with the openings 7 on the left and the layer below with the perforated pipe 12 on the right. A pressure wave guided along the pipe 12 continuously forms bubbles 6 along the path travelled, so that bubbles 6 are released from adjacent openings 7 at a certain time interval and a spatially and temporally predetermined pattern of gas injection is realized. This reduces undesirable interactions, such as the merging of individual bubbles produced one after the other at the same opening 7.

FIG. 10 shows a side view of a further exemplary embodiment in which the gas supply 1 opens into a cavity in the gas modulation unit 4, which now modulates the supplied gas from below. Funnels 13 or funnel-shaped structures are provided below the openings 7 as perforations in a plate, which focus the gas onto the openings 7. By focusing pressure waves locally, the electrical energy required to generate the bubbles 6 can be reduced compared to a situation in which the pressure wave strikes the perforated plate directly.

FIG. 11 shows a schematic three-dimensional view of the gasification tank 16, with a gasification device arranged therein with several bubble diffusers 5 and a meandering connection between them. In this way, gas bubbles can be introduced over a large area into the liquid 8 contained in the gasification tank 16, for example waste water, in which a liquid column with a height typically in the range of 4 m to 5 m lies above the openings 7, although smaller and larger liquid columns are also possible. In biological wastewater treatment, air or pure oxygen is typically used as a gas, but other gases can also be introduced depending on the application, for example ozone for trace elimination, biogas or sewage gas or carbon dioxide for membrane cleaning. Other application examples include oxygen supply in aquaculture or fish farming, flotation in the extraction of raw materials in mining and in mining recycling, reduction of noise emissions in off-shore work by forming at least one bubble curtain, for dispensing medication or for mixing and mass transfer in chemical processes.

Typically, the gasification device is operated continuously, but intermittent emission of pressure waves can also be provided. In further embodiments, in addition to the control unit 3 as a pressure control unit, which sets the pressure level to a specific level, an acoustic damper or the acoustic damping unit 14 can also be provided, which prevents the reflection of acoustic waves at the end of the bubble diffuser 5, the gas supply 1 or the pipe 12. It is also possible to connect the gas modulation unit 4 to a signal generator, or the gas modulation unit 4 already comprises the signal generator, so that harmonic signals, i.e. sinusoidal waves, with adjustable amplitude and frequency are generated. An electrical or electronic amplifier can also be provided to amplify the signals from the signal generator.

The size of the resulting bubbles 6 is determined by several parameters, namely the size of the openings 7, the frequency of the pressure of the modulated signal, the signal amplitude and the pressure difference between the gas in the gas supply 1 or parts connected to it and a critical pressure level that applies to the formation of bubbles in the respective liquid 8.

It may be provided that the gas is maintained at a static pressure level that is 20 percent below this critical level, i.e. 20 percent below the minimum pressure at which bubbles 6 begin to form. The control unit 3 is typically designed to maintain this level with an accuracy of 1 percent. As shown in FIG. 12, a continuous sinusoidal pressure signal generated by the signal generator and transmitted via an amplifier to a loudspeaker of the gas modulation unit 4 can generate an acoustic pressure wave that propagates along the gas supply line 1 and/or the pipe 12. The resulting oscillating instantaneous pressure value is shown over time in FIG. 12. FIG. 12 shows three periods of an exemplary signal in which the original signal of the signal generator is compared with pressure variations. The pressure wave shows gas compression for half a period, followed by relaxation for the rest of the period. The maximum acoustic pressure gradient is sufficient to lead to the spontaneous formation of a bubble 6 as soon as the critical pressure is exceeded. The diameters of the generated bubbles 6 can typically be set between 0.01 mm and 5 mm.

For example, with a pressure wave of a frequency of 165 Hz and a pressure of 0.6 kPa below the critical pressure (which in this example corresponds to 103.5 kPa), a bubble formation can be achieved, since the local pressure level below one of the openings 7 is brought to a pressure level above the critical pressure by the pressure wave, and thus a spontaneous bubble formation begins, in which a bubble forms within a few milliseconds.

FIG. 13 shows the different phases of bubble formation in a diagram. In each case, the normalized and therefore not unitized pressure is plotted against time. FIG. 13a) shows the gasification device at low acoustic frequencies. When the first acoustic wave reaches the opening 7 in this first operating mode, a sufficiently large pressure difference is provided to produce bubbles 6. Due to the low frequency, the bubble 6 has enough time to grow and the buoyancy force is significant. The detachment of the bubble 6 from the opening 7 is also due to the buoyancy force. The initial detachment of the bubble 6 takes place at the time t_{d}<0.5tₚ, i.e. at a time at which the pressure difference caused by the acoustic wave is positive. tₚ denotes the duration of a complete period of the pressure wave and ta the time required for the bubble 6 to detach from the opening 7. In this first operating mode, the start of bubble formation can be controlled, but not the bubble size.

FIG. 13b) shows a second operating mode in which bubble formation takes place between 0.5tₚ<t_{d}<0.75tₚ. During bubble formation, the bubble 6 expands and contracts successively and eventually forms a small bubble 6. In this case, detachment is determined by hydrodynamic forces. In this second operating mode, the bubble size and the frequency of bubble formation can be determined by adjusting the properties of the acoustic wave. For example, bubble sizes between 0.5 mm and 0.7 mm can be generated in a frequency range of 168 Hz to 182 Hz of the acoustic wave. If the pressure difference is increased, the frequency tends to be lower, for example 154-612 Hz, and the size of the bubbles is 1.1-1.5 mm.

FIG. 13c) shows a third operating mode in which neither the bubble size nor the formation frequency of the bubbles can be controlled. The duration of bubble formation is 0.75tₚ<t_{d}<tₚ. In this operating mode, the waiting time for detachment is too short for the bubble 6 to detach from the opening 7. Finally, FIG. 13d) shows a fourth operating mode for high frequencies of the acoustic wave. In this case, the frequency is set too high and the bubble 6 cannot detach from the opening 7. In principle, however, bubbles 6 with defined properties can be formed continuously at any frequency, provided that the original pressure level is set accordingly. For this reason, the control unit 3 is used to provide a constant gas pressure or a constant gas volume flow, so that the first operating mode or the second operating mode can be achieved by adjusting the parameters of the modulation by the gas modulation unit 4. However, it is also true that the operating modes depend on the gas and liquid used 8 as well as the size of the openings 7, the liquid column above the openings 7, the amplitude and frequency of the acoustic wave and finally the response of the gasification device to the intended frequency range. FIG. 16 shows the formation of bubbles in the various operating modes, with FIG. 16a) showing the first operating mode, FIG. 16b) the second operating mode, FIG. 16c) the third operating mode and FIG. 16d) the fourth operating mode.

FIG. 14 shows an example of the variation of the bubble size in the left part of the figure and the bubble frequency in the right part of the figure with the signal frequency in the second operating mode. The size of the opening 7 is 0.81 mm in the exemplary embodiment shown. The hydrostatic pressure level is kept constant at 200 mm above the opening 7 and the measurement is carried out at atmospheric pressure. In addition, the amplitude of the acoustic signal is kept constant. Regardless of the pressure difference, the maximum achievable bubble size is reached at 161 Hz, whereas the frequency of bubble generation depends on the frequency of the acoustic signal. In a particularly advantageous way, the frequency of the acoustic signal can be tuned to the resonance frequency of the gasification device used, as shown in FIG. 15 in a corresponding diagram.

FIG. 17 shows a further diagram of a pressure modulation that can be generated according to one embodiment. In this case, the pressure modulation is periodic, but not necessarily harmonic (e.g. not sinusoidal). Instead, the pressure curve p plotted over the time t describes a kind of sawtooth profile, whereby the real pressure curve can also be somewhat less sharp-edged than the variant shown due to inertia effects and other imperfections.

A period of pressure modulation is made up of two time proportions tA and tB. FIG. 17 shows an example of two periods and the corresponding time end points T1 and T2, whereby the number of periods can be increased as required.

Each period comprises a pressure modulation to a level above a critical pressure Pcrt and to a level below. Within a first time proportion tA, the pressure is initially increased to an amplitude A1 compared to the critical pressure Pcrt. The pressure is then lowered, whereby an amplitude A2 below the critical pressure Pcrt is reached within a second time proportion tB.

It has been shown that an initial rapid increase in pressure to a level well above the critical pressure Pcrt is advantageous for rapid and reliably controllable bubble formation. With the subsequent pressure reduction during the time proportion tB, which is shorter in time compared to the time proportion tA and deviates less from the critical pressure Pcrt in terms of amount, the bubble that has already formed proproportionally is reliably released with its size finally determined.

The respective differences D1, D2 of the amplitudes A1, A2 of the time proportions tA, tB to the critical pressure Pcrt are shown in FIG. 17 and differ noticeably from each other. For example, the difference D1 is at least twice as large as the difference D2.

FIG. 17 also shows that the integral of the pressure p over time t (i.e. the area between the pressure modulation curve and the time axis) is greater over the duration of the first time proportion tA than over the duration of the second time proportion tB. Thus, an energy input corresponding to this integral and area is greater during the first time proportion tA than during the second time proportion tB.

Features of the various embodiments disclosed only in the exemplary embodiments can be combined with each other and claimed individually.

### LIST OF REFERENCE SIGNS

1 Gas supply
2 Valve
3 Control unit
4 Gas modulation unit
5 Bubble diffuser
6 Bubble
7 Opening
8 Liquid
9 Actuator
10 Gas pressure wave
11 Standing wave
12 Perforated pipe
13 Funnel
14 Damping unit
15 Gas supply line
16 Gasification tank

1-14. (canceled)

15. A gasification device for the gasification of a liquid medium
with a gas supply, a control unit, a gas modulation unit and a bubble diffuser, wherein
the gas supply is configured to supply a gas to the control unit, the gas modulation unit and the bubble diffuser,
the control unit is configured to control the gas volume flow or the pressure of the gas supplied to the gas modulation unit and to supply it to the gas modulation unit in such a way that the gas is supplied to the gas modulation unit at a constant gas volume flow and/or a constant gas pressure, and
the gas modulation unit is configured to vary the gas volume flow and/or the pressure and to supply it to the liquid medium via the bubble diffuser provided with at least one opening, so that at least one bubble is formed at the opening of the bubble diffuser in the liquid medium.

16. The gasification device according to claim 15, wherein the gas modulation unit has at least one electrically controllable actuator that is at least one electro-acoustic transducer and/or at least one electro-acoustic actuator.

17. The gasification device according to claim 15, wherein the gas modulation unit and the bubble diffuser are integrally designed.

18. The gasification device according to claim 15, wherein the bubble diffuser has a plurality of openings at each of which at least one electrically controllable actuator, which is an electro-acoustic transducer and/or an electro-acoustic actuator, is arranged for forming different bubble patterns.

19. The gasification device according to claim 15, wherein an acoustic damping unit is arranged in the bubble diffuser, which is designed to prevent back reflections.

20. The gasification device according to claim 15, wherein the control unit is configured to direct the gas to the gas modulation unit at a gas pressure which is up to 20 percent lower than a critical pressure for bubble generation for the respective liquid medium.

21. The gasification device according to claim 15, wherein the gas modulation unit has a signal generator or is connected to a signal generator which is designed to apply periodic modulations of adjustable amplitude and frequency to the gas volume flow or the gas pressure through the gas modulation unit.

22. The gasification device according to claim 21, wherein the modulations are harmonic.

23. The gasification device according to claim 21,
wherein a respective period of the modulation comprises a first time proportion with a pressure above a critical pressure for bubble generation for the respective liquid medium and a subsequent second time proportion with a pressure below the critical pressure, wherein:
a) the time proportions are different from each other; and/or
b) the amounts of the differences of the amplitudes of each time proportion at the critical pressure are different from each other; and/or
c) the integrals of the pressure over the duration of the time proportions are different from each other.

24. The gasification device according to option b) of claim 23,
wherein the amount of the difference between the amplitude of the first time proportion and the critical pressure is greater than the amount of the difference between the amplitude of the second time proportion and the critical pressure.

25. The gasification device according to option c) of claim 23,
wherein the integral of the pressure over time within the first time proportion is greater than the integral of the pressure over time within the second time proportion.

26. A gasification tank including a gasification device according to claim 15.

27. A method for generating bubbles in a liquid medium, in which a gas is directed through the gas supply, the control unit, the gas modulation unit and the bubble diffuser in gasification tank filled with the liquid medium by the gasification device arranged below a surface of the liquid medium according to claim 15, the control unit controlling the gas volume flow and/or the pressure of the gas supplied in such a way that the gas is supplied to the gas modulation unit with a constant gas volume flow and/or a constant gas pressure, wherein the gas modulation unit provides the gas with a gas volume flow modulation and/or a gas pressure modulation and supplies it to the bubble diffuser provided with at least one opening, so that at least one bubble is formed at the opening of the bubble diffuser and is supplied to the liquid medium.

28. Use of a gasification device for the gasification of a liquid medium with a gas supply, a control unit, a gas modulation unit and a bubble diffuser, wherein
the gas supply is configured to supply a gas to the control unit, the gas modulation unit and the bubble diffuser,
the control unit is configured to control the gas volume flow or the pressure of the gas supplied to the gas modulation unit and to supply it to the gas modulation unit in such a way that the gas is supplied to the gas modulation unit at a constant gas volume flow and/or a constant gas pressure, and
the gas modulation unit is configured to vary the gas volume flow and/or the pressure and to supply it to the liquid medium via the bubble diffuser provided with at least one opening, so that at least one bubble is formed at the opening of the bubble diffuser in the liquid medium
wherein the gas is directed through the gas supply, the control unit, the gas modulation unit and the bubble diffuser in a gasification tank filled with the liquid medium by the gasification device arranged below a surface of the liquid medium, the control unit controlling the gas volume flow and/or the pressure of the gas supplied in such a way that the gas is supplied to the gas modulation unit with a constant gas volume flow and/or a constant gas pressure, wherein the gas modulation unit provides the gas with a gas volume flow modulation and/or a gas pressure modulation and supplies it to the bubble diffuser provided with at least one opening, so that at least one bubble is formed at the opening of the bubble diffuser and is supplied to the liquid medium for a waste water treatment process comprising the introduction of air or oxygen into an activated sludge tank or for the introduction of ozone into a tank for trace elimination, for supplying oxygen in aquaculture or fish farming, for cleaning membrane filters, for flotation in the extraction of raw materials in mining and in mining recycling, for reducing noise emissions in off-shore work by forming at least one bubble curtain, for dispensing medication or for mixing and mass transfer in chemical processes.
